(19) United States
(12) Patent Application Publication
(10) Pub. No.: US 2016/0203672 A1
(43) Pub. Date: Jul. 14, 2016

(54) METHOD FOR CONFIGURING GAMING DEVICES VIA A NETWORK

(71) Applicant: Patent Investment & Licensing Company, Las Vegas, NV (US)

(72) Inventor: JOHN F. ACRES, LAS VEGAS, NV (US)

(21) Appl. No.: 15/076,318

(22) Filed: Mar. 21, 2016

Related U.S. Application Data
(63) Continuation of application No. 14/670,764, filed on Mar. 27, 2015.
Application No. 14/670,764 is a division of application No. 12/268,614, filed on Nov. 11, 2008, now abandoned.
(60) Provisional application No. 60/987,293, filed on Nov. 12, 2007.

(51) Int. Cl. G07F 17/32

(52) U.S. Cl. CPC G07F 17/3225

(57) ABSTRACT

Embodiments of the present invention are directed to a method for configuring gaming machines in which configuration data packets are associated with a player's record in a player tracking system. The configuration data packets may have machine identification information in a header that may be associated with each data packet. When a player is recognized at a gaming machine, the player's record is retrieved from the network and data packets associated with the machine at which the player is recognized are read and used to configure the gaming device. Furthermore, data related to outcomes of games played by the player on multiple machines may be collected and used to award a bonus to the player, the bonus being awarded in response to collecting a predefined plurality of outcomes. Data related to bonuses accrued and used may also be associated with the player's record.

### RELATED APPLICATIONS

This application is a continuation of U.S. Non-provisional application Ser. No. 14/670,764, filed Mar. 27, 2015, which is a divisional application of U.S. Non-provisional application Ser. No. 12/268,614 filed Nov. 11, 2008, which claims the benefit of U.S. Provisional Application No. 60/987,293 filed Nov. 12, 2007, all of which are hereby incorporated herein in their entirety.

### FIELD OF THE INVENTION

This disclosure relates generally to networked gaming devices and more particularly to configuring gaming devices via the network.

### BACKGROUND

Player tracking systems for accumulating data related to the players of networked gaming devices, typically in casinos, are known in the prior art. In these systems, a player is urged to register with a casino by providing the casino with at least the player's name and address, although typically other demographic and personal information of interest to the casino is acquired. In exchange, the casino implements a mechanism, typically a player identification card issued to the player, which allows the player to be recognized at each gaming machine where the player gambles. This recognition typically results from inserting the card in a card reader associated with each of the gaming devices. The network then accumulates, in a record associated with the player, data related to the amount wagered by the player. This enables the casino to provide the player with points proportional to amounts wagered by the player. These points may be redeemed for goods and services, much like a frequent flier mileage program, including for further wagering. The casino can also base decisions to provide complementary goods and services the players based on their player tracking data.

It would be desirable to use similar systems or existing player tracking systems to configure gaming devices according to the desires of the casino or the player. It would also be beneficial to use such systems to accumulate information based on outcomes of games played by the players and to configure the gaming devices, including providing bonuses to the players, based on the accumulated information.

### BRIEF DESCRIPTION OF THE DRAWINGS

FIG. 1A is a functional block diagram that illustrates a gaming device according to embodiments of the invention.

FIG. 1B is an isometric view of the gaming device illustrated in FIG. 1A.

FIGS. 2A, 2B, and 2C are detail diagrams of exemplary types of gaming devices according to embodiments of the invention.

FIG. 3 is a functional block diagram of networked gaming devices according to embodiments of the invention.

FIG. 4 is a schematic diagram of a player's record including gaming-device configuration data packets that may be used according to an embodiment of the present method.

FIG. 5 is a view of a gaming device being played according to an embodiment of the present method.

FIG. 6 is a view of a gaming device that that may be played according to an embodiment of the present method.

### DETAILED DESCRIPTION

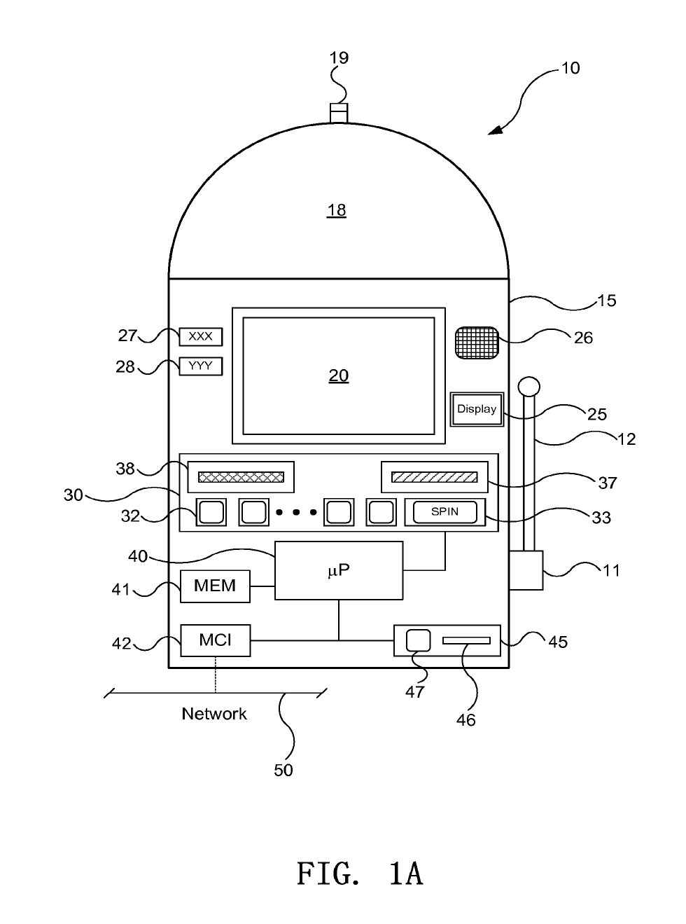

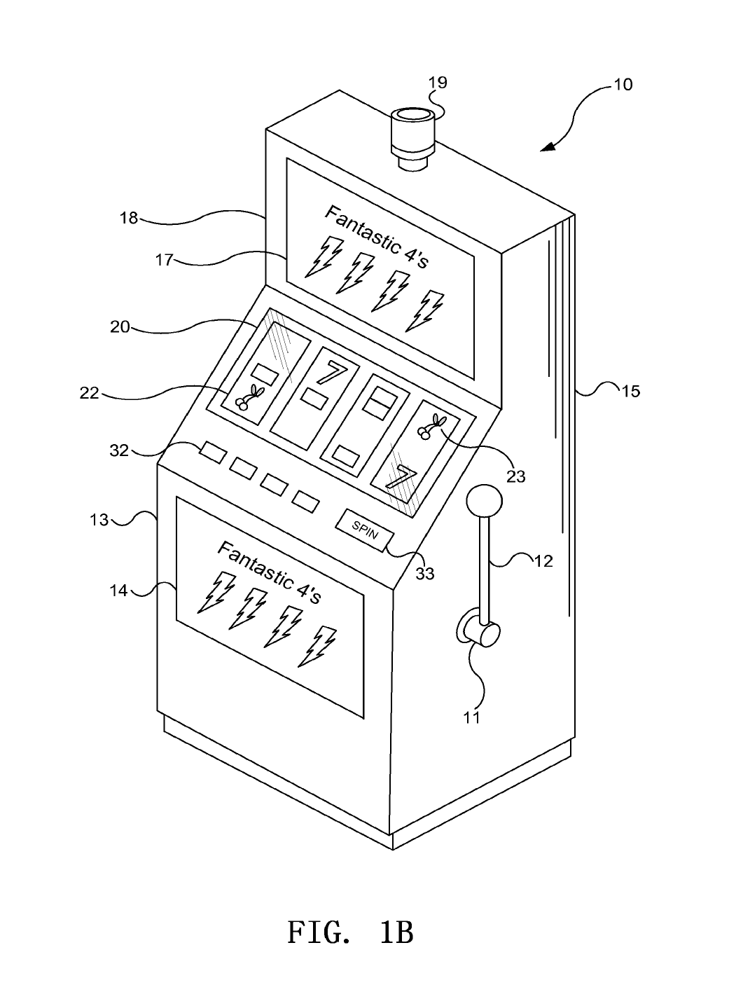

FIGS. 1A and 1B illustrate example gaming devices according to embodiments of the invention.

Referring to FIGS. 1A and 1B, a gaming device 10 is an electronic gaming machine. Although an electronic gaming machine or “slot” machine is illustrated, various other types of devices may be used to wager monetarily based credits on a game of chance in accordance with principles of the invention. The term “electronic gaming device” is meant to include various devices such as electro-mechanical spinning-reel type slot machines, video slot machines, and video poker machines, for instance. Other gaming devices may include computer-based gaming machines, wireless gaming devices, multi-player gaming stations, modified personal electronic gaming devices (such as cell phones), personal computers, server-based gaming terminals, and other similar devices. Although embodiments of the invention will work with all of the gaming types mentioned, for ease of illustration the present embodiments will be described in reference to the electronic gaming machine 10 shown in FIGS. 1A and 1B.

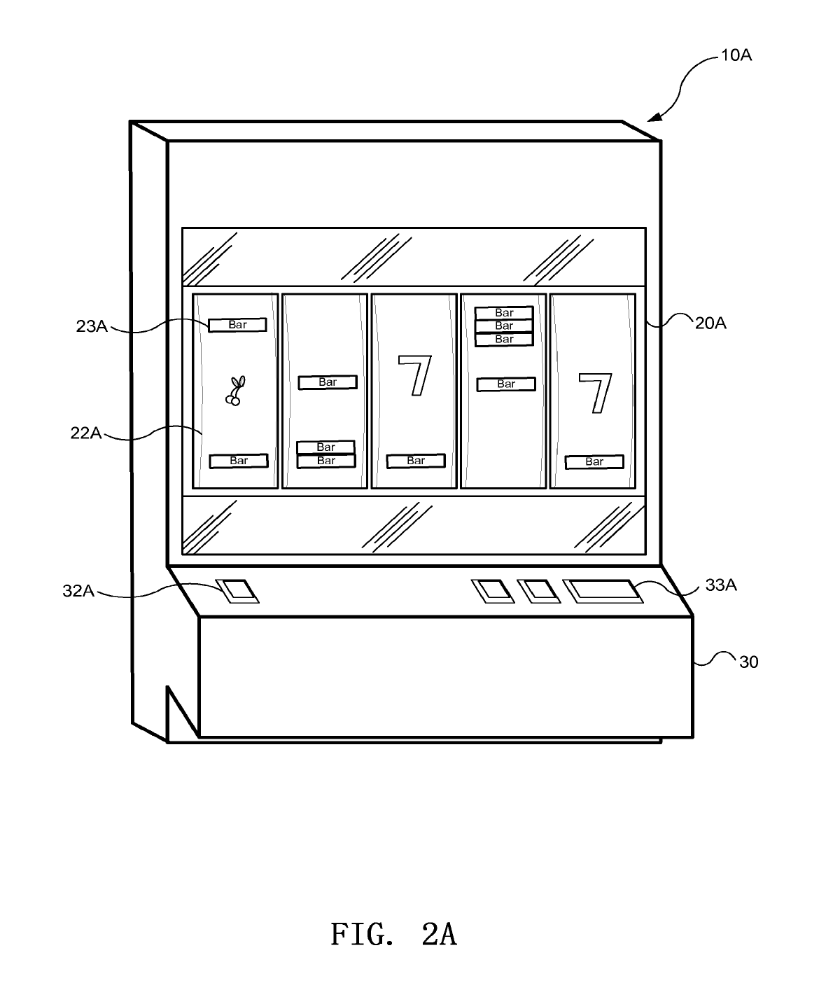

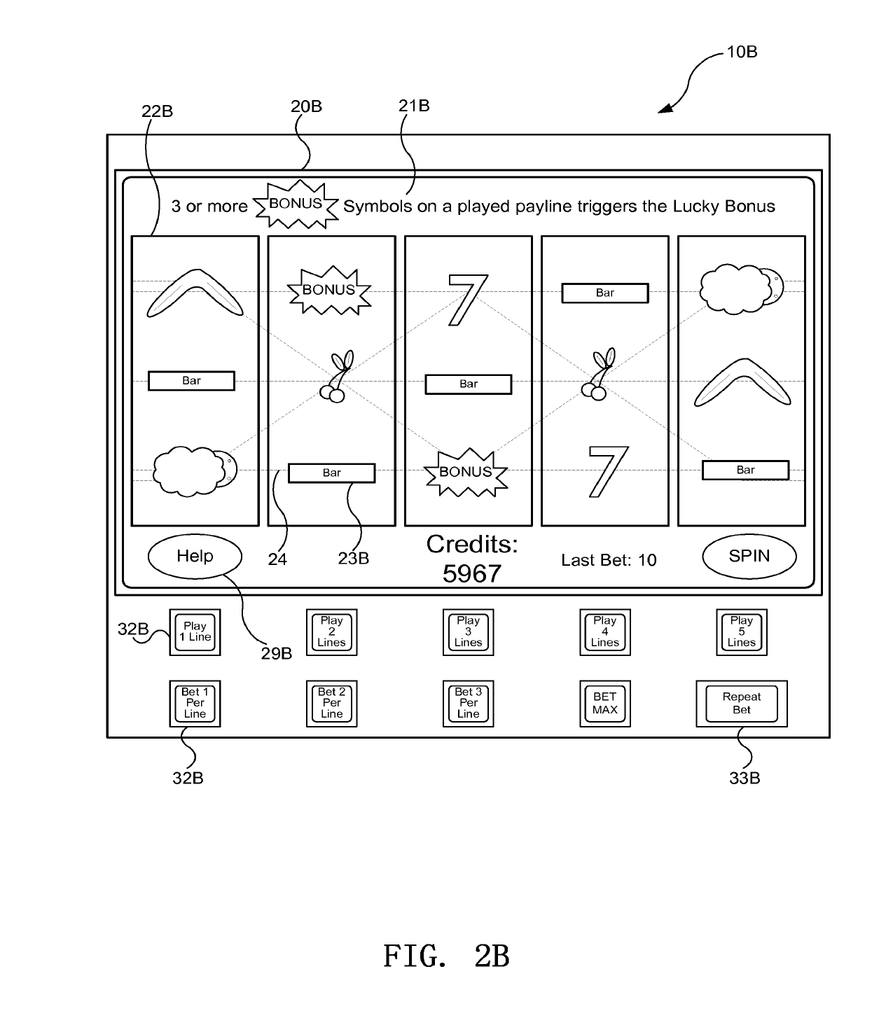

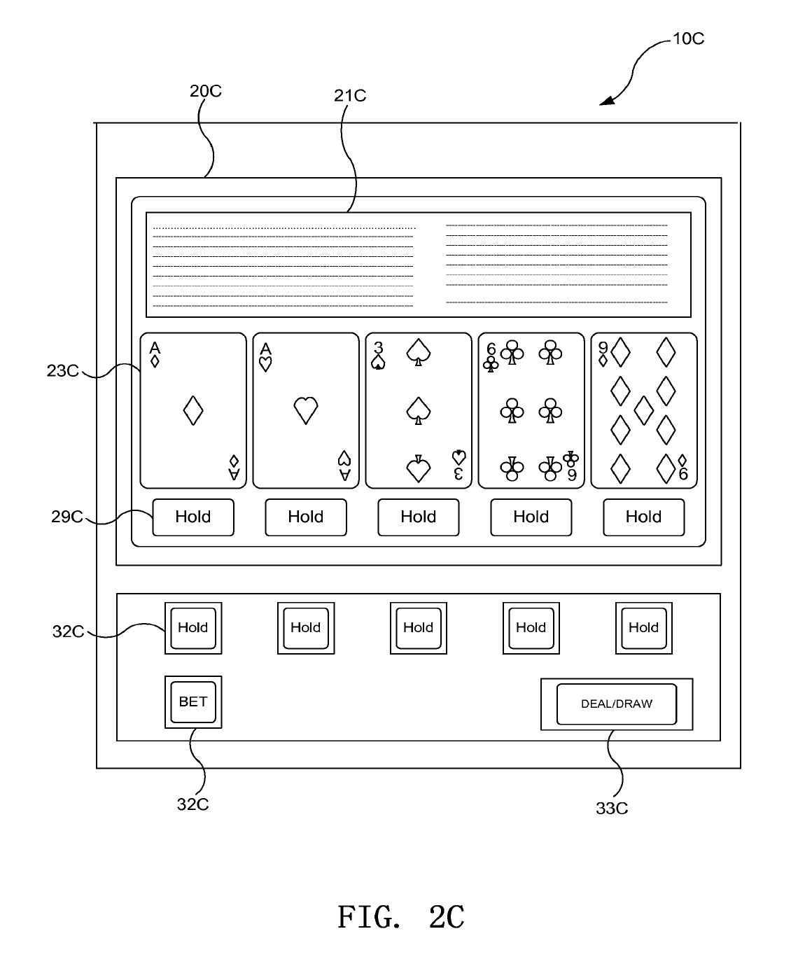

The gaming device 10 includes a cabinet 15 housing components to operate the gaming device 10. The cabinet 15 may include a gaming display 20, a base portion 13, a top box 18, and a player interface panel 30. The gaming display 20 may include mechanical spinning reels (FIG. 2A), a video display (FIGS. 2B and 2C), or a combination of both spinning reels and a video display (not shown). The gaming cabinet 15 may also include a credit meter 27 and a coin-in or bet meter 28. The credit meter 27 may indicate the total number of credits remaining on the gaming device 10 that are eligible to be wagered. In some embodiments, the credit meter 27 may reflect a monetary unit, such as dollars. However, it is often preferable to have the credit meter 27 reflect a number of ‘credits,’ rather than a monetary unit. The bet meter 28 may indicate the amount of credits to be wagered on a particular game. Thus, for each game, the player transfers the amount that he or she wants to wager from the credit meter 27 to the bet meter 28. In some embodiments, various other meters may be present, such as meters reflecting amounts won, amounts paid, or the like. In embodiments where the gaming display 20 is a video monitor, the information indicated on the credit meters may be shown on the gaming display itself 20 (FIG. 2B).

The base portion 13 may include a lighted panel 14, a coin return (not shown), and a gaming handle 12 operable on a partially rotating pivot joint 11. The game handle 12 is traditionally included on mechanical spinning-reel games, where the handle may be pulled toward a player to initiate the spinning of reels 22 after placement of a wager. The top box 18 may include a lighted panel 17, a video display (such as an LCD monitor), a mechanical bonus device (not shown), and a candle light indicator 19. The player interface panel 30 may include various devices so that a player can interact with the gaming device 10.

The player interface panel 30 may include one or more game buttons 32 that can be actuated by the player to cause the gaming device 10 to perform a specific action. For example, some of the game buttons 32 may cause the gaming device 10 to bet a credit to be wagered during the next game, change the number of lines being played on a multi-line game, cash out the credits remaining on the gaming device (as indicated on the credit meter 27), or request assistance from casino personnel, such as by lighting the candle 19. In addition, the player interface panel 30 may include one or more game actuating buttons 33. The game actuating buttons 33 may initiate a game with a pre-specified amount of credits. On some gaming devices 10 a “Max Bet” game actuating button 33 may be included that places the maximum credit wager on a game and initiates the game. The player interface panel 30 may further include a bill acceptor 37 and a ticket printer 38. The bill acceptor 37 may accept and validate paper money or previously printed tickets with a credit balance. The ticket printer 38 may print out tickets reflecting the balance of the credits that remain on the gaming device 10 when a player cashes out by pressing one of the game buttons 32 programmed to cause a ‘cashout.’ These tickets may be inserted into other gaming machines or redeemed at a cashier station or kiosk for cash.

The gaming device 10 may also include one or more speakers 26 to transmit auditory information or sounds to the player. The auditory information may include specific sounds associated with particular events that occur during game play on the gaming device 10. For example, a particularly festive sound may be played during a large win or when a bonus is triggered. The speakers 26 may also transmit “attract” sounds to entice nearby players when the game is not currently being played.

The gaming device 10 may further include a secondary display 25. This secondary display 25 may be a vacuum fluorescent display (VFD), a liquid crystal display (LCD), a cathode ray tube (CRT), a plasma screen, or the like. The secondary display 25 may show any combination of primary game information and ancillary information to the player. For example, the secondary display 25 may show player tracking information, secondary bonus information, advertisements, or player selectable game options.

The gaming device 10 may include a separate information window (not shown) dedicated to supplying any combination of information related to primary game play, secondary bonus information, player tracking information, secondary bonus information, advertisements or player selectable game options. This window may be fixed in size and location or may have its size and location vary temporally as communication needs change. One example of such a resizable window is International Game Technology's “service window”. Another example is Las Vegas Gaming Incorporated's retrofit technology which allows information to be placed over areas of the game or the secondary display screen at various times and in various situations.

The gaming device 10 includes a microprocessor 40 that controls operation of the gaming device 10. If the gaming device 10 is a standalone gaming device, the microprocessor 40 may control virtually all of the operations of the gaming devices and attached equipment, such as operating game logic stored in memory (not shown) as firmware, controlling the display 20 to represent the outcome of a game, communicating with the other peripheral devices (such as the bill acceptor 37), and orchestrating the lighting and sound emanating from the gaming device 10. In other embodiments where the gaming device 10 is coupled to a network 50, as described below, the microprocessor 40 may have different tasks depending on the setup and function of the gaming device. For example, the microprocessor 40 may be responsible for running the base game of the gaming device and executing instructions received over the network 50 from a bonus server or player tracking server. In a server-based gaming setup, the microprocessor 40 may act as a terminal to execute instructions from a remote server that is running game play on the gaming device.

The microprocessor 40 may be coupled to a machine communication interface (MCI) 42 that connects the gaming device 10 to a gaming network 50. The MCI 42 may be coupled to the microprocessor 40 through a serial connection, a parallel connection, an optical connection, or in some cases a wireless connection. The gaming device 10 may include memory 41 (MEM), such as a random access memory (RAM), coupled to the microprocessor 40 and which can be used to store gaming information, such as storing total coin-in statistics about a present or past gaming session, which can be communicated to a remote server or database through the MCI 42. The MCI 42 may also facilitate communication between the network 50 and the secondary display 25 or a player tracking unit 45 housed in the gaming cabinet 15.

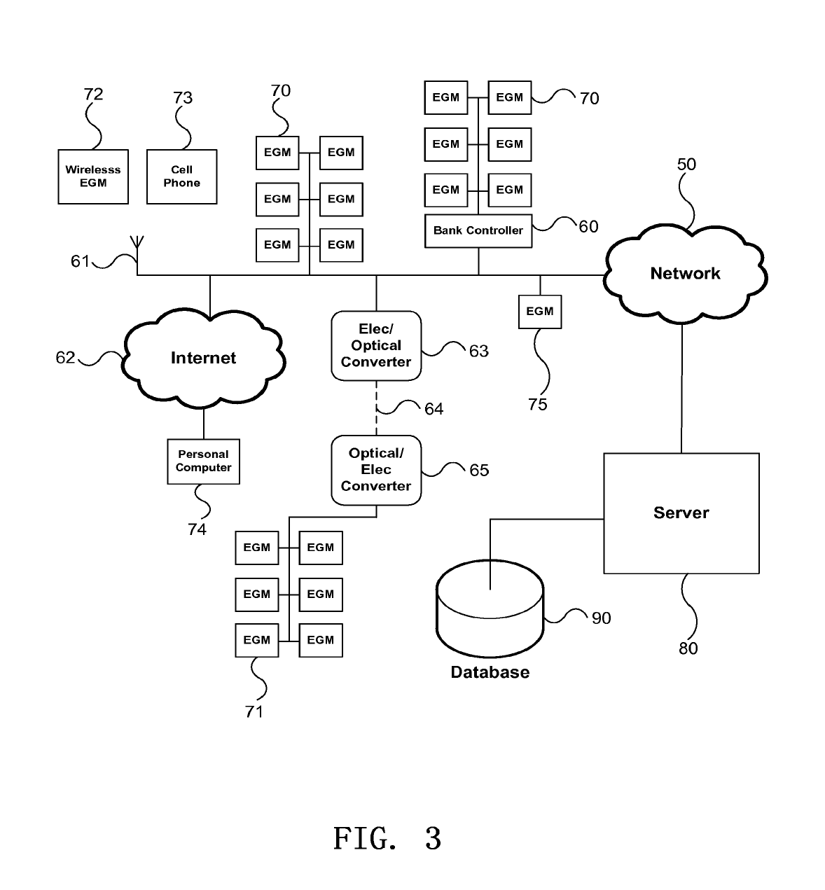

The player tracking unit 45 may include an identification device 46 and one or more buttons 47 associated with the player tracking unit 45. The identification device 46 serves to identify a player, by, for example, reading a player-tracking device, such as a player tracking card that is issued by the casino to individual players who choose to have such a card. The identification device 46 may instead, or additionally, identify players through other methods. Player tracking systems using player tracking cards and card readers 46 are known in the art. Briefly summarizing such a system, a player registers with the casino prior to commencing gaming. The casino issues a unique player-tracking card to the player and opens a corresponding player account that is stored on a server or host computer, described below with reference to FIG. 3. The player account may include the player's name and mailing address and other information of interest to the casino in connection with marketing efforts. Prior to playing one of the gaming devices in the casino, the player inserts the player tracking card into the identification device 46 thus permitting the casino to track player activity, such as amounts wagered, credits won, and rate of play.

To induce the player to use the card and be an identified player, the casino may award each player points proportional to the money or credits wagered by the player. Players typically accrue points at a rate related to the amount wagered, although other factors may cause the casino to award the player various amounts. The points may be displayed on the secondary display 25 or using other methods. In conventional player tracking systems, the player may take his or her card to a special desk in the casino where a casino employee scans the card to determine how many accrued points are in the player's account. The player may redeem points for selected merchandise, meals in casino restaurants, or the like, which each have assigned point values. In some player tracking systems, the player may use the secondary display 25 to access their player tracking account, such as to check a total number of points, redeem points for various services, make changes to their account, or download promotional credits to the gaming device 10. In other embodiments, the identification device 46 may read other identifying cards (such as driver licenses, credit cards, etc.) to identify a player and match them to a corresponding player tracking account. Although FIG. 1A shows the player tracking unit 45 with a card reader as the identification device 46, other embodiments may include a player tracking unit 45 with a biometric scanner, PIN code acceptor, or other methods of identifying a player to pair the player with their player tracking account.

During typical play on a gaming device 10, a player plays a game by placing a wager and then initiating a gaming session. The player may initially insert monetary bills or previously printed tickets with a credit value into the bill acceptor 37. The player may also put coins into a coin acceptor (not shown) or a credit, debit or casino account card into a card reader/authorizer (not shown). One of skill in the art will readily see that this invention is useful with all gambling devices, regardless of the manner in which wager value-input is accomplished.

The credit meter 27 displays the numeric credit value of the money inserted dependent on the denomination of the gaming device 10. That is, if the gaming device 10 is a nickel slot machine and a $20 bill inserted into the bill acceptor 37, the credit meter will reflect 400 credits or one credit for each nickel of the inserted twenty dollars. For gaming devices 10 that support multiple denominations, the credit meter 27 will reflect the amount of credits relative to the denomination selected. Thus, in the above example, if a penny denomination is selected after the $20 is inserted the credit meter will change from 400 credits to 2000 credits.

A wager may be placed by pushing one or more of the game buttons 32, which may be reflected on the bet meter 28. That is, the player can generally depress a “bet one” button (one of the buttons on the player interface panel 30, such as 32), which transfers one credit from the credit meter 27 to the bet meter 28. Each time the button 32 is depressed an additional single credit transfers to the bet meter 28 up to a maximum bet that can be placed on a single play of the electronic gaming device 10. The gaming session may be initiated by pulling the gaming handle 12 or depressing the spin button 33. On some gaming devices 10, a “max bet” button (another one of the buttons 32 on the player interface panel 30) may be depressed to wager the maximum number of credits supported by the gaming device 10 and initiate a gaming session.

If the gaming session does not result in any winning combination, the process of placing a wager may be repeated by the player. Alternatively, the player may cash out any remaining credits on the credit meter 27 by depressing the “cash-out” button (another button 32 on the player interface panel 30), which causes the credits on the credit meter 27 to be paid out in the form of a ticket through the ticket printer 38, or may be paid out in the form of returning coins from a coin hopper (not shown) to a coin return tray.

If instead a winning combination (win) appears on the display 20, the award corresponding to the winning combination is immediately applied to the credit meter 27. For example, if the gaming device 10 is a slot machine, a winning combination of symbols 23 may land on a played payline on reels 22. If any bonus games are initiated, the gaming device 10 may enter into a bonus mode or simply award the player with a bonus amount of credits that are applied to the credit meter 27.

FIGS. 2A to 2C illustrate exemplary types of gaming devices according to embodiments of the invention. FIG. 2A illustrates an example spinning-reel gaming machine 10A, FIG. 2B illustrates an example video slot machine 10B, and FIG. 2C illustrates an example video poker machine 10C.

Referring to FIG. 2A, a spinning-reel gaming machine 10A includes a gaming display 20A having a plurality of mechanical spinning reels 22A. Typically, spinning-reel gaming machines 10A have three to five spinning reels 22A. Each of the spinning reels 22A has multiple symbols 23A that may be separated by blank areas on the spinning reels 22A, although the presence of blank areas typically depends on the number of reels 22A present in the gaming device 10A and the number of different symbols 23A that may appear on the spinning reels 22A. Each of the symbols 22A or blank areas makes up a “stop” on the spinning reel 22A where the reel 22A comes to rest after a spin. Although the spinning reels 22A of various games 10A may have various numbers of stops, many conventional spinning-reel gaming devices 10A have reels 22A with twenty two stops.

During game play, the spinning reels 22A may be controlled by stepper motors (not shown) under the direction of the microprocessor 40 (FIG. 1A). Thus, although the spinning-reel gaming device 10A has mechanical based spinning reels 22A, the movement of the reels themselves is electronically controlled to spin and stop. This electronic control is advantageous because it allows a virtual reel strip to be stored in the memory 41 of the gaming device 10A, where various “virtual stops” are mapped to each physical stop on the physical reel 22A. This mapping allows the gaming device 10A to establish greater awards and bonuses available to the player because of the increased number of possible combinations afforded by the virtual reel strips.

A gaming session on a spinning reel slot machine 10A typically includes the player pressing the “bet-one” button (one of the game buttons 32A) to wager a desired number of credits followed by pulling the gaming handle 12 (FIGS. 1A, 1B) or pressing the spin button 33A to spin the reels 22A. Alternatively, the player may simply press the “max-bet” button (another one of the game buttons 32A) to both wager the maximum number of credits permitted and initiate the spinning of the reels 22A. The spinning reels 22A may all stop at the same time or may individually stop one after another (typically from left to right) to build player anticipation. Because the display 20A usually cannot be physically modified, some spinning reel slot machines 10A include an electronic display screen in the top box 18 (FIG. 1B), a mechanical bonus mechanism in the top box 18, or a secondary display 25 (FIG. 1A) to execute a bonus.

Referring to FIG. 2B, a video gaming machine 10B may include a video display 20B to display virtual spinning reels 22B and various other gaming information 21B. The video display 20B may be a CRT, LCD, plasma screen, or the like. It is usually preferable that the video display 20B be a touchscreen to accept player input. A number of symbols 23A appear on each of the virtual spinning reels 22B. Although FIG. 2B shows five virtual spinning reels 22B, the flexibility of the video display 20B allows for various reel 22B and game configurations. For example, some video slot games 10B spin reels for each individual symbol position (or stop) that appears on the video display 20B. That is, each symbol position on the screen is independent of every other position during the gaming sessions. In these types of games, very large numbers of pay lines or multiple super scatter pays can be utilized since similar symbols could appear at every symbol position on the video display 20B. On the other hand, other video slot games 10B more closely resemble the mechanical spinning reel games where symbols that are vertically adjacent to each other are part of the same continuous virtual spinning reel 22B.

Because the virtual spinning reels 22B, by virtue of being computer implemented, can have almost any number of stops on a reel strip, it is much easier to have a greater variety of displayed outcomes as compared to spinning-reel slot machines 10A (FIG. 2A) that have a fixed number of physical stops on each spinning reel 22A.

With the possible increases in reel 22B numbers and configurations over the mechanical gaming device 10A, video gaming devices 10B often have multiple paylines 24 that may be played. By having more paylines 24 available to play, the player may be more likely to have a winning combination when the reels 22B stop and the gaming session ends. However, since the player typically must wager at least a minimum number of credits to enable each payline 24 to be eligible for winning, the overall odds of winning are not much different, if at all, than if the player is wagering only on a single payline. For example, in a five line game, the player may bet one credit per payline 24 and be eligible for winning symbol combinations that appear on any of the five played paylines 24. This gives a total of five credits wagered and five possible winning paylines 24. If, on the other hand, the player only wagers one credit on one payline 24, but plays five gaming sessions, the odds of winning would be identical as above: five credits wagered and five possible winning paylines 24.

Because the video display 20B can easily modify the image output by the video display 20B, bonuses, such as second screen bonuses are relatively easy to award on the video slot game 10B. That is, if a bonus is triggered during game play, the video display 20B may simply store the resulting screen shot in memory and display a bonus sequence on the video display 20B. After the bonus sequence is completed, the video display 20B may then retrieve the previous screen shot and information from memory, and re-display that image.

Also, as mentioned above, the video display 20B may allow various other game information 21B to be displayed. For example, as shown in FIG. 2B, banner information may be displayed above the spinning reels 22B to inform the player, perhaps, which symbol combination is needed to trigger a bonus. Also, instead of providing a separate credit meter 27 (FIG. 1A) and bet meter 28, the same information can instead be displayed on the video display 20B. In addition, “soft buttons” 29B such as a “spin” button or “help/see pays” button may be built using the touch screen video display 20B. Such customization and ease of changing the image shown on the display 20B adds to the flexibility of the game 10B.

Even with the improved flexibility afforded by the video display 20B, several physical buttons 32B and 33B are usually provided on video slot machines 10B. These buttons may include game buttons 32B that allow a player to choose the number of paylines 24 he or she would like to play and the number of credits wagered on each payline 24. In addition, a max bet button (one of the game buttons 32B) allows a player to place a maximum credit wager on the maximum number of available paylines 24 and initiate a gaming session. A repeat bet or spin button 33B may also be used to initiate each gaming session when the max bet button is not used.

Referring to FIG. 2C, a video poker gaming device 10C may include a video display 20C that is physically similar to the video display 20B shown in FIG. 2B. The video display 20C may show a poker hand of five cards 23C and various other player information 21C including a paytable for various winning hands, as well as a plurality of player selectable soft buttons 29C. The video display 20C may present a poker hand of five cards 23C and various other player information 21C including a number of player selectable soft (touch-screen) buttons 29C and a paytable for various winning hands. Although the embodiment illustrated in FIG. 3C shows only one hand of poker on the video display 20C, various other video poker machines 10C may show several poker hands (multi-hand poker). Typically, video poker machines 10C play “draw” poker in which a player is dealt a hand of five cards, has the opportunity to hold any combination of those five cards, and then draws new cards to replace the discarded ones. All pays are usually given for winning combinations resulting from the final hand, although some video poker games 10C may give bonus credits for certain combinations received on the first hand before the draw. In the example shown in FIG. 2C a player has been dealt two aces, a three, a six, and a nine. The video poker game 10C may provide a bonus or payout for the player having been dealt the pair of aces, even before the player decides what to discard in the draw. Since pairs, three of a kind, etc. are typically needed for wins, a player would likely hold the two aces that have been dealt and draw three cards to replace the three, six, and nine in the hope of receiving additional aces or other cards leading to a winning combination with a higher award amount. After the draw and revealing of the final hand, the video poker game 10C typically awards any credits won to the credit meter.

The player selectable soft buttons 29C appearing on the screen respectively correspond to each card on the video display 20C. These soft buttons 29C allow players to select specific cards on the video display 20C such that the card corresponding to the selected soft button is “held” before the draw. Typically, video poker machines 10C also include physical game buttons 32C that correspond to the cards in the hand and may be selected to hold a corresponding card. A deal/draw button 33C may also be included to initiate a gaming session after credits have been wagered (with a bet button 32C, for example) and to draw any cards not held after the first hand is displayed.

Although examples of a spinning reel slot machine 10A, a video slot machine 10B, and a video poker machine 10C have been illustrated in FIGS. 2A-2C, gaming machines and various other types of gaming devices known in the art are contemplated and are within the scope of the invention.

FIG. 3 is a block diagram illustrating networked gaming devices according to embodiments of the invention. Referring to FIG. 3, multiple electronic gaming devices (EGMs) 70, 71, 72, 73, 74, and 75 may be coupled to one another and coupled to a remote server 80 through a network 50. For ease of understanding, gaming devices or EGMs 70, 71, 72, 73, 74, and 75 are generically referred to as EGMs 70-75. The term EGMs 70-75, however, may refer to any combination of one or more of EGMs 70, 71, 72, 73, 74, and 75. Additionally, the gaming server 80 may be coupled to one or more gaming databases 90. These gaming network 50 connections may allow multiple gaming devices 70-75 to remain in communication with one another during particular gaming modes such as tournament play or remote head-to-head play. Although some of the gaming devices 70-75 coupled on the gaming network 50 may resemble the gaming devices 10, 10A, 10B, and 10C shown in FIGS. 1A-1B and 2A-2C, other coupled gaming devices 70-75 may include differently configured gaming devices. For example, the gaming devices 70-75 may include traditional slot machines 75 directly coupled to the network 50, banks of gaming devices 70 coupled to the network 50, banks of gaming devices 70 coupled to the network through a bank controller 60, wireless handheld gaming machines 72 and cell phones 73 coupled to the gaming network 50 through one or more wireless routers or antennas 61, personal computers 74 coupled to the network 50 through the internet 62, and banks of gaming devices 71 coupled to the network through one or more optical connection lines 64. Additionally, some of the traditional gaming devices 70, 71, and 75 may include electronic gaming tables, multi-station gaming devices, or electronic components operating in conjunction with non-gaming components, such as automatic card readers, chip readers, and chip counters, for example.

Gaming devices 71 coupled over an optical line 64 may be remote gaming devices in a different location or casino. The optical line 64 may be coupled to the gaming network 50 through an electronic to optical signal converter 63 and may be coupled to the gaming devices 71 through an optical to electronic signal converter 65. The banks of gaming devices 70 coupled to the network 50 may be coupled through a bank controller 60 for compatibility purposes, for local organization and control, or for signal buffering purposes. The network 50 may include serial or parallel signal transmission lines and carry data in accordance with data transfer protocols such as Ethernet transmission lines, Rs-232 lines, firewire lines, USB lines, or other communication protocols. Although not shown in FIG. 3, substantially the entire network 50 may be made of fiber optic lines or may be a wireless network utilizing a wireless protocol such as IEEE 802.11 a, b, g, or n, Zigbee, RF protocols, optical transmission, near-field transmission, or the like.

As mentioned above, each gaming device 70-75 may have an individual processor 40 (FIG. 1A) and memory 41 to run and control game play on the gaming device 70-75, or some of the gaming devices 70-75 may be terminals that are run by a remote server 80 in a server based gaming environment. Server based gaming environments may be advantageous to casinos by allowing fast downloading of particular game types or themes based on casino preference or player selection. Additionally, tournament based games, linked games, and certain game types, such as BINGO or keno may benefit from at least some server 80 based control.

Thus, in some embodiments, the network 50, server 80, and database 90 may be dedicated to communications regarding specific game or tournament play. In other embodiments, however, the network 50, server 80, and database 90 may be part of a player tracking network. For player tracking capabilities, when a player inserts a player tracking card in the card reader 46 (FIG. 1A), the player tracking unit 45 sends player identification information obtained on the card reader 46 through the MCI 42 over the network 50 to the player tracking server 80, where the player identification information is compared to player information records in the player database 90 to provide the player with information regarding their player account or other features at the gaming device 10 where the player is wagering. Additionally, multiple databases 90 and/or servers 80 may be present and coupled to one or more networks 50 to provide a variety of gaming services, such as both game/tournament data and player tracking data.

The various systems described with reference to FIGS. 1-3 can be used in a number of ways. For instance, the systems can be used to track data about various players. The tracked data can be used by the casino to provide additional benefits to players, such as extra bonuses or extra benefits such as bonus games and other benefits as described above. These added benefits further entice the players to play at the casino that provides the benefits.

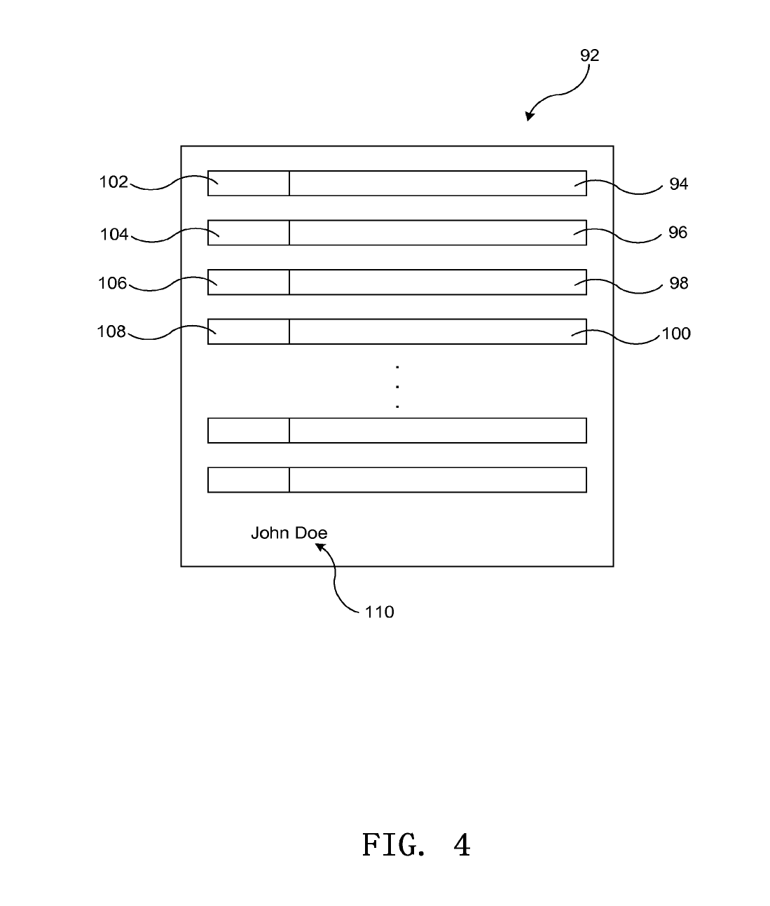

Turning now to FIG. 4, indicated generally at 92 is a schematic view of a player's record. In the present implementation, the record is comprised of digital data, but is represented schematically as shown to facilitate description of the structure of the record and its use in implementing the method. In addition to conventional player-tracking data (not shown), the player's record includes a plurality of gaming-device data configuration packets 94, 96, 98, 100, etc. Each packet includes a header, like headers 102, 104, 106, 108 in packets 94, 96, 98, 100, respectively. The header includes data that associates each packet with one or more particular gaming devices 70-75. This may be done by associating each gaming device with a unique number and then incorporating the numbers for each associated gaming device into the proper header.

Although the present embodiment illustrates an implementation of the method by associating a single player with each record, the method could be equally well implemented by associating a plurality of players with a single record.

As described above, a player may be recognized at one of the gaming devices, such as video gaming machine 10B. This may occur, e.g., when the player inserts his or her card into card reader 46. The player tracking unit 45 reads the card to locate a unique player digital identification, depicted as the player's name 110 in FIG. 4, which is assigned to the player when he or she enrolls in the player tracking program. After reading the card, record 92 is fetched from server 80 and stored in player tracking unit 45. Alternatively, the method may be implemented by leaving the record on network 50, e.g., on server 80. In this alternative, the record is updated by transmitting data between gaming machine 10B and the server rather than transmitting data between the gaming machine and player tracking unit 45 and thereafter returning the record to server 80.

As mentioned above, gaming device numbers in each of headers 102, 104, 106, 108 may be associated with one more of gaming devices 70-75. For example, one packet may have a header that associates the packet with all gaming machines of a particular class, e.g., video poker machines. Or the header could associate the packet with video poker machines made by a particular manufacturer. Other possibilities include headers that associate the packet with all of the gaming machines in a particular bank of machines. There could even be a header that associates the packet with a single identified gaming machine. Or another header might be associated with each of gaming devices 70-75 on the network.

Some of the packets contain state information, i.e., they accumulate data related to the outcomes of games played by the player on a gaming device that is associated with the packet via the packet header. These state-information packets may also contain stored bonuses earned by the player, or the bonuses may be stored in another packet that may or may not be associated with the same gaming machines as the state-information packets. Still others of the packets contain information related to the player's or the casino's preferences for gaming machines. Before describing how the method of the present invention is implemented, a more detailed description of each of the types of packets will be provided, starting with packets that contain state information.

These state-information packets accumulate information related to the outcomes of games played by the player. Strictly speaking, these packets may not configure the gaming device but may only accumulate information that in turn is ultimately used to configure the gaming device or a different gaming device played at a later time. For example, rules may be implemented for providing a bonus based on the state information. As will be described in more detail, the rules are programmed in computer code and may be stored at the gaming device or on the network. One such rule may pay a bonus upon the occurrence of a predefined gaming-device outcome. Another rule might provide a bonus as a result of a plurality of outcomes such as successively achieved outcomes or outcomes accumulated over time. For example, the player could be provided a bonus by striking BAR BAR BAR three times over a defined period or by a certain date, or by striking BAR BAR BAR in one game and 7 7 7 in another. The possible permutations and combinations are limitless. Although the rule could be written to require accumulation of the predefined symbols within a single gaming session, the outcomes could also be gathered over multiple playing sessions.

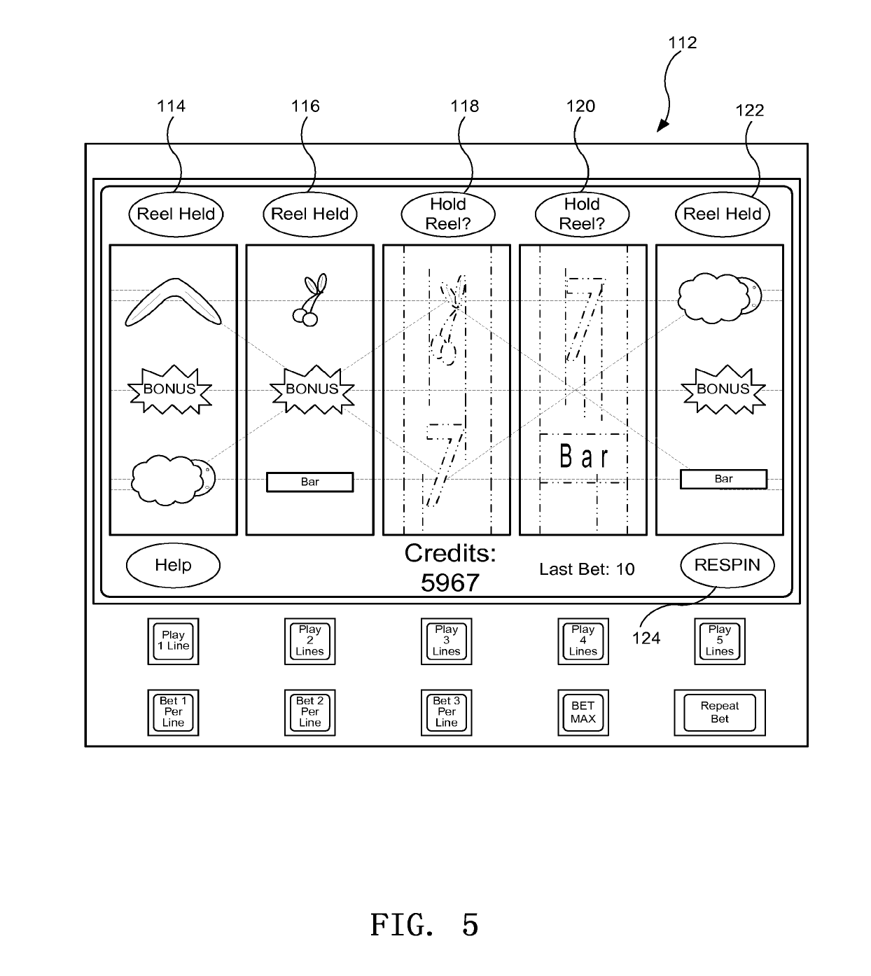

The rules may also specify the nature of the bonus. The bonus could be further credits for playing the gaming devices or complementary goods and services offered by the casino. In addition, the bonus could be one of a nudge, hold, or respin. A hold comprises the opportunity to hold one or more of the symbols that makes up the outcome of a slot machine or video slot machine game. The other symbols in the outcome, i.e., those not held, may be regenerated to produce a new outcome that also includes the held symbol(s). An example of a gaming device implementing this feature is indicated generally at 112 in FIG. 5.

Machine 112 is similar to machine 10B in FIG. 2B and generally operates in the same manner except for the hold feature that is implemented using touchscreen hold buttons 114, 116, 118, 120, 122 and a touchscreen respin button 124. In operation, the player may be notified that he or she has qualified according to the bonus rules for a bonus award. The notification may occur using the secondary display 25 (in FIG. 1A), which is associated with most of the gaming devices, although not shown on each. As mentioned above, the rules may permit accumulation of outcomes from a variety of gaming devices, even different types of devices, such as video poker and video slot machines, and over a plurality of gaming sessions.

Once the player decides to use the hold bonus on the outcome of one of the games played on gaming machine 112, he or she touches selected ones of buttons 114-122 to hold certain of the outcomes of the reels. The rules may be written to permit the player to hold only a single outcome under some circumstances, a pair of outcomes under other circumstances, or any number of outcomes. In FIG. 5, gaming machine 112 is shown after the player has touched buttons 114, 116, 122 and then touched respin button 124. This holds the first, second, and fifth reels and spins the third and fourth reels as shown. After the spinning reels produce new outcomes, the player is entitled to the outcome of all five reels, including the new outcomes of the third and fourth reels and the held outcomes of the first, second, and fifth reels. Thereafter, the player's record is updated to reflect the fact that this bonus has been used.

A respin bonus is similar to the hold bonus except that all five reels respin, i.e., none are held. As with the hold, the player's record is updated to reflect that the respin bonus has been used.

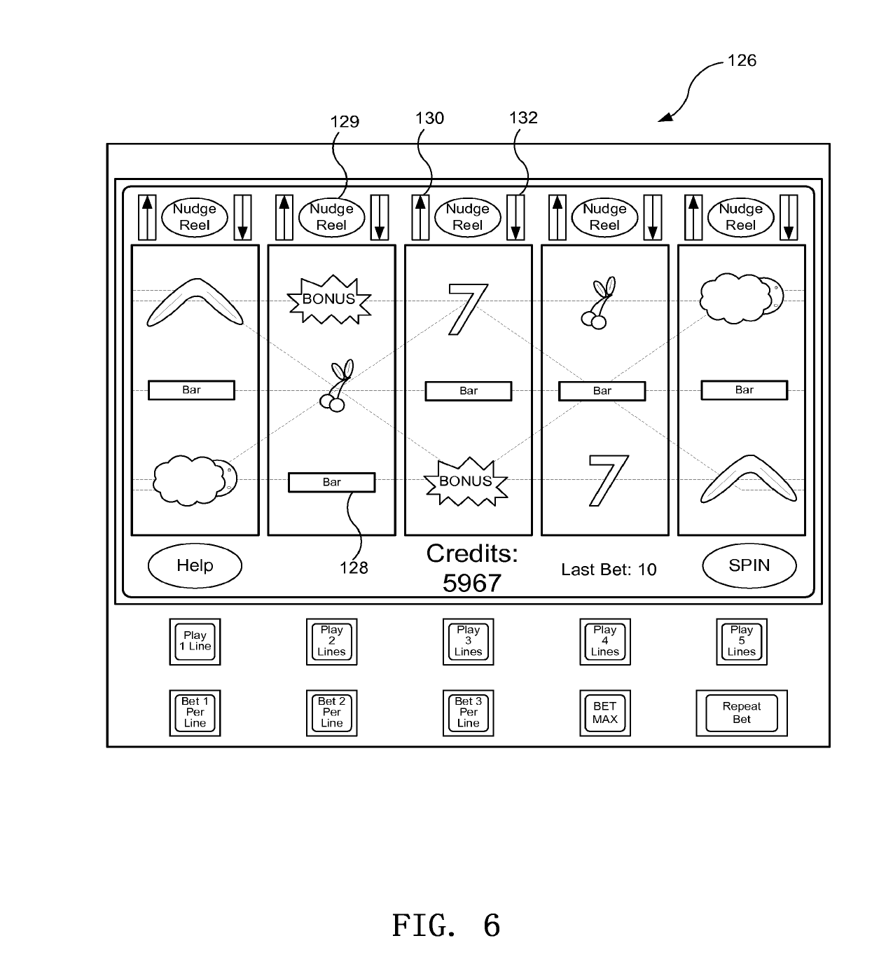

The nudge feature is implemented on a gaming device 126 in FIG. 6. A nudge comprises the opportunity to change the outcome on one or more of the reels of a slot machine or of a slot machine simulated in a video slot game by permitting a player to select one or more reels and nudge them to the next stop. For example, if the player is entitled to a nudge bonus and generates the outcome shown in FIG. 6, the player might choose to nudge the second reel up one stop to align bar symbol 128. This is accomplished by using the Nudge Reel touch screen button 129 and then indicating which direction to move the reel, either up one stop or down one stop, by touching an up arrow 130 or a down arrow 132. In this case, or course, the player will want to nudge the second reel up one stop to align all of the bars thereby producing a winning outcome. After doing so, the player's record is updated to indicate that this bonus was used.

It should be appreciated that the method of the present invention may be fully implemented without requiring the machines shown in FIGS. 5 and 6. In other words, bonuses could be awarded that do not require implementing nudges, holds, or respins. What is more, as will be seen, the present method can be fully implemented to configure aspects of gaming devices that do not involve awarding a bonus. Although FIGS. 5 and 6 demonstrate gaming machines that are useful for awarding particular types of bonuses, other forms of bonuses could also be awarded. For example, one bonus might include a free game or a series of free games. The game(s) might only be usable on a certain date or within a defined time period. Another bonus might be a reduced-cost game, which might—or might not—also be used within limited times. One form of awarding free or reduced costs games is by applying credits to credit meter 27. Such credits could be limited to play on the gaming machines, i.e., restricted from being paid out to the player.

Still another type of bonus is paying a specified amount upon the occurrence of a predefined game outcome. For example, 10% could be added to all jackpots. These also could be limited to certain time periods or to certain machines, e.g., only machines in certain bank or area of the casino, or both.

Consideration will now be given to how the method is implemented by following a typical player, in this case, John Doe, the player associated with record 92 in FIG. 4, as he registers in casino's player tracking club and then plays a variety of games in the casino. Mr. Doe registers with the player tracking club by providing his name, address, and contact information. In addition, he may be able to specify preferences at one or more gaming machines or classes of gaming machines. For example, Mr. Doe, may have a desired level of gaming machine volatility along the range from few wins with bigger jackpots to many wins with smaller jackpots. This might be specified in packet 94, which is in turn associated with one or more of the gaming machines, either by identifying particular machine numbers in header 102 or by inserting data in the header that identifies a class of machines, e.g., all video poker machines. Alternatively, all machines in the casino could be identified, either by including all numbers or a universal identifier. As will be seen, this identification of machine(s) in the header results in play of the identified machines(s) being configured with the specified volatility. Of course, the casino, as opposed to the player, might also use the data packet to specify a particular volatility on particular machine(s) for the player.

Other preferences that the casino or the player might specify upon registration, include the appearance of a gaming machine or a class of gaming machines when the player is recognized at the gaming machine. This could include light color, image display, or any other aspect of configurable gaming machine appearance. In addition, the player could specify a language that the machine would use to label controls, display results, or provide instructions, or for other words appearing on or displayed by the gaming device. These preferences would appear in a packet that identified only the machines so configurable. As a result, there might be a number of different packets, all relating to different machines or to a different class or classes of machines. For example, some brands or classes of gaming machines might not be configurable in the same way as others.

Still other preferences could be used to personalize a machine, several machines, or a class of machines for the player. One way of so doing is to permit the player to store a digital image upon registration and associating the image with his or her record. This could be a lucky symbol or a favorite relative. This image would be associated with a packet having a header that identifies machines that could load and display the image, for example, on a portion of gaming display 20A, 20B, or 20C or on a portion of secondary display 25. A personalized greeting—specified by the casino or the player—could also be associated with a packet that in turn is associated, via its header, with a machine or a class of machines that could display the greeting on the gaming display, the secondary display or another display associated with the gaming device at which the player is recognized. As with preferences related to machine appearance, the preferences that personalize the gaming machine might need to be stored in a number of different packets to accommodate formats or information required by different types or brands of machines. In other words, different packets are either used by a gaming machine if the machines header identification is included in the header or ignored by the gaming machine if its identification is not in the header.

The data packets may be entered into the player's record using the same work station (not shown) that is used to set up the player tracking record. A person of ordinary skill in the art could readily implement a software program, or modify an existing player tracking program, in a way that would display the various configuration options on the workstation used by a casino employee to register a player. Commands at the work station result in entry of the appropriate data packets into the player's record, which in one embodiment is stored on database server 90 along with the player tracking records associated with the player. Typical player tracking records include data about the amount wagered by the player and information about player tracking points accrued by the player, which may be displayed at secondary display 25. One advantage of the present method is that it can be implemented using an existing player tracking system with the only possible additional hardware requirement being additional storage space such as another or a larger database server. Of course, the present invention may also be implemented separately.

When the player is first enrolled, selected data packets are associated with the player's record. First, there may be one or more data packets for personal preferences such as machine color, choice of a language used by displays and controls on the machine, a color scheme or other configuration affecting appearance, etc. Because there are typically different types of machines—e.g., video poker and video slot machines—as well as machines of the same type made by different manufacturers, there may need to be a number of different data packets, or data segments within a packet, to accommodate configuration of different machine features and different formats for the same feature from machine to machine. Upon registration, the player may also provide a digital image that is associated with the player's record in database 90 at the work station.

Data packets that implement bonuses that are personal to the player may also be associated with the player's record, either upon registration or later as determined by the casino. For example, the player could be provided with a double jackpot bonus on certain identified machines only between the hours of 2 AM and 8 AM. And this could be valid for a limited duration, e.g., 48 hours from when the data packet was first associated with the player's record or until a specified date and time. Electronic gaming machines that can receive a programmed command to pay over and above the paytable for the gaming device are known in the art, and a person of ordinary skill could create a data packet to provide a double-jackpot bonus, as well as the other bonuses described herein. The double jackpot is provided by issuing a command to the slot machine to pay out the value of the jackpot each time the machine, under control of its paytable, issues a jackpot thus providing a double-jackpot bonus.

Still another bonus that could be configured via a data packet associated with the player's record is an award of credits to the credit meter of a gaming device that is identified in the data packet's header. This might also be limited in time and applied only upon certain conditions being met, e.g., a consecutive number of losing bets or credits, a consecutive number of winning bets or credits, randomly, when the player is recognized by the player tracking system, etc. The types of bonuses and the conditions and limits for awarding them are virtually limitless.

As described above, the hold, respin, and nudge bonuses could be awarded upon accumulation of a predefined combination of gaming outcomes over a limited or unlimited time period. Each time one of gaming machine produces one of these outcomes, it is stored in one or more of the data packets. There may be different data packets for different classes and/or manufacturers of games. As a result, the player can accrue the qualifying outcomes over multiple gaming sessions that may span days, weeks, months, or even years, depending upon how the rule for awarding the bonus is written.

Once the qualifying number of outcomes occurs, the fact that the player is entitled to a bonus is stored in one of the data packets, either the same one that accumulates the outcomes or a different one. The header of the packet in which the bonuses are stored includes information identifying machines upon which the bonus may be used. If the player has a bonus ready for use, e.g., a nudge, and is playing a video poker machine, the data packet containing data indicating that a nudge is available will not include information in its header that identifies any of the video poker games. As a result, that packet is not loaded at a video poker game.

It should be noted that the rules, which comprise software code that reads the data packets and then issues configuration commands to the slot machine where the player is recognized, may be stored anywhere on the network. In one approach the code is stored at the gaming machine, e.g., in player tracking unit 45 or in the gaming machine. Using either of these approaches reduces the amount of network traffic with the record being retrieved from database 90 at the start of the session and then read and updated locally during the gaming session. At the conclusion of the session, the updated record, reflecting bonuses earned and used and outcomes accrued toward a possible future bonus, is returned over the network to database 90.

The personal aspect of providing bonuses in this manner can be see by considering how another identified player, let's call her Jane Doe, has data packets associated with her record. Upon registration, she also provides her name and contact information and could be provided with some bonuses available for use as a reward for joining the player tracking system. She can also specify her preferences as Mr. Doe did but could specify entirely different preferences. In addition, she might be viewed by the casino as being a more potentially valuable player than Mr. Doe and therefore be provided with a richer selection of bonuses, e.g., double jackpots for 24 hours rather than only during the off hours limitation imposed on Mr. Doe.

Like Mr. Doe, she can be awarded bonuses for accruing certain outcomes spread out over different gaming sessions. But her outcomes might be entirely different and perhaps easier—or harder—to accumulate before a bonus is awarded. Casinos—as are other businesses—increasingly manage relationships with customers by collecting data about the customer, both in relationship to the customers' behavior in the casino and from other sources. The present implementation provides a tool for precisely targeting individual players and rewarding or incentivizing them in ways that benefit both the player and the casino.

Some embodiments of the invention have been described above, and in addition, some specific details are shown for purposes of illustrating the inventive principles. However, numerous other arrangements may be devised in accordance with the inventive principles of this patent disclosure. Further, well known processes have not been described in detail in order not to obscure the invention. Thus, while the invention is described in conjunction with the specific embodiments illustrated in the drawings, it is not limited to these embodiments or drawings. Rather, the invention is intended to cover alternatives, modifications, and equivalents that come within the scope and spirit of the inventive principles set out in the appended claims.

1. A method of operating a plurality of gaming devices interconnected by a communications network comprising:
tracking the outcomes of at least some of the games played;
identifying a plurality of outcomes;
indicating to a player of at least one of the games that a bonus is awarded upon the occurrence of the selected plurality of outcomes in the player's tracked outcomes; and
awarding the bonus on the gaming device.

2. The method of claim 1 wherein tracking the outcomes of at least some of the games played comprises:
creating a record for the player;
storing at least some of the player's game outcomes in the record.

3. The method of claim 2 further comprising:
associating the record with at least one of the gaming devices;
recognizing the player at one of the gaming devices; and
awarding the bonus if the game at which the player is recognized is a game with which the record is associated.

4. The method of claim 3 further comprising:
creating a plurality of gaming-device configuration data packets;
associating each of the packets with one or more identified gaming devices;
storing the packets in the record;
reading the packets each time the player is recognized at one of the gaming devices; and
configuring the gaming device according to one or more of the packets.

5. The method of claim 1 further comprising:
creating a record for the player;
storing player preferences in the player's record; and
configuring a game played by the player according to the preferences.

6. The method of claim 1 wherein awarding the bonus comprises enabling the player to change the outcome of one of the games played on one of the gaming devices.

7. The method of claim 6 wherein enabling the player to change the outcome of one of the games played on one of the gaming devices comprises enabling the gaming device for at least one of a nudge, hold, and respin.

8. A method of distributing player-specific game-configuration data over a network of gaming devices comprising:
creating a plurality of gaming-device configuration data packets;
associating each of the gaming-device configuration data packets with at least one gaming device on the network;
storing one of the gaming-device configuration data packets in a player-tracking record of one of the players of a gaming device on the network;
tracking outcomes of at least some of a plurality of games played on gaming devices with which the stored one of the data packets is associated;
storing the tracked outcomes in the one data packet;
when the stored tracked outcomes satisfy a predefined criteria, awarding a bonus game to the one player in whose player-tracking record the one data packet is stored;
storing bonus data indicative of the awarded bonus game in the one data packet;
receiving indicia that identifies the one player at one of the gaming devices;
transmitting the player-tracking record for the one player from a stored location to the one gaming device;
accessing the one data packet in the player-tracking record; and
accessing the bonus data in the one data packet, wherein programming code in combination with the bonus data configures the one gaming device to play a bonus game.

9. The method of claim 8 wherein awarding the bonus comprises enabling the player to change the outcome of one of the games played on one of the gaming devices.

10. The method of claim 9 wherein enabling the player to change the outcome of one of the games played on one of the gaming devices comprises enabling the gaming device for at least one of a nudge, hold, and respin.

11. A method of distributing game-configuration data over a network of gaming devices comprising:
creating a plurality of gaming-device configuration data packets;
associating each of the gaming-device configuration data packets with at least one gaming device on the network;
storing one of the gaming-device configuration data packets in a player-tracking record of one of the players of a gaming device on the network;
awarding a bonus game to the one player in whose player-tracking record the one data packet is stored;
storing bonus data indicative of the awarded bonus game in the one data packet;
receiving indicia that identifies the one player at one of the gaming devices;
transmitting the player-tracking record for the one player from a stored location to the one gaming device;
accessing the one data packet in the player-tracking record; and
accessing the bonus data in the one data packet, wherein programming code in combination with the bonus data configures the one gaming device to play a bonus game.

12. The method of claim 11 wherein awarding the bonus comprises enabling the player to change the outcome of one of the games played on one of the gaming devices.

13. The method of claim 12 wherein enabling the player to change the outcome of one of the games played on one of the gaming devices comprises enabling the gaming device for at least one of a nudge, hold, and respin.
